(19) United States
(12) Patent Application Publication
(10) Pub. No.: US 2019/0015866 A1
(43) Pub. Date: Jan. 17, 2019

(54) PAINT ROLLER GUIDE

(71) Applicants: Daniel SWEENEY, (US); Scott A. PYLE, (US)

(72) Inventors: Daniel SWEENEY, (US); Scott A. PYLE, (US)

(21) Appl. No.: 15/750,610

(22) PCT Filed: Sep. 28, 2015
(86) PCT No.: PCT/US15/52546

§ 371 Date: Feb. 6, 2018

Related U.S. Application Data
(60) Provisional application No. 62/056,558, filed on Sep. 28, 2014.

(51) Int. Cl. B05C 17/02

(52) U.S. Cl. CPC B05C 17/0222; B05C 17/0245

(57) ABSTRACT

A paint roller guide includes a mounting structure configured to be positioned adjacent a portion of a paint roller frame, and a flexible surface configured to bend according to a dimension of the portion of the paint roller frame so as to snap together the mounting structure and the portion of the paint roller frame. A guide arm is mounted to the mounting structure. The guide arm may be configured to rotate in multiple directions relative to a length of the mounting structure.

### I. CLAIM OF PRIORITY

This application is a continuation patent application of, and claims priority from, U.S. Provisional Patent Application Ser. No. 62/056,558, filed on Sep. 28, 2014, which is incorporated by reference herein in its entirety for all purposes.

### II. FIELD OF THE DISCLOSURE

The disclosure relates to painting products such as paint rollers.

### III. BACKGROUND

Ceilings typically do not require painting each time when walls are repainted. When a ceiling or trim molding is accidentally bumped with a wet paint roller, the mistake can be an unexpected hassle and costly fix. Touching up the spot with old, leftover ceiling paint from the last time the ceiling was painted is rarely a solution as the ceiling color has often faded and the touch up never seems to be a match. Repainting the ceiling costs unanticipated time and money.

### IV. SUMMARY OF THE DISCLOSURE

A particular embodiment includes an apparatus comprising a mounting structure configured to be positioned adjacent, or proximate, a portion of a paint roller frame, and a flexible surface configured to bend according to a dimension of the portion of the paint roller frame so as to snap together the mounting structure and the portion of the paint roller frame. A guide arm may be configured to rotate in multiple directions relative to a length of the mounting structure.

According to another or the same embodiment, the flexible, or pliable, surface comprises at, least a portion of the mounting structure. The flexible surface may include a flexible tab or a spring clamp. The apparatus may be assembled using a two part assembly process. The portion of the paint roller frame may have a diameter ranging from about 4.70 mm to about 9 mm. The mounting structure may be proximate a rounded portion, bended, or corner section of the paint roller frame.

According to another or the same embodiment, the guide arm includes at least one of a squared tip, rounded tip, and, an L-shaped tip. A length of the guide arm may be fixed or adjustable. A rotating joint may be used to attach the guide arm to the mounting structure. The rotating joint may include at least one of a ratchet joint and a ball and socket joint. The guide arm may include an offset curvature (e.g., an S-curve or L-curve). A locking mechanism may selectively secure a position of the guide arm relative to the mounting structure.

According to another embodiment, an apparatus includes a mounting structure configured to be attached to a paint roller frame, wherein a first section of the mounting structure extends in a first direction corresponding to a first direction of the paint roller frame, and wherein a second section extends in a second direction that corresponds to a bend in the paint roller frame. A guide arm is attached or otherwise configured to move relative to the mounting structure.

The apparatus may be constructed using a two part assembly process. The guide arm, length may be adjustable, and the portion of the paint roller frame may have a diameter ranging from about 4.70 mm to about 9 mm.

According to another embodiment, a method of manufacturing a paint roller guide may include constructing a mounting structure configured to be positioned adjacent a portion of a paint roller frame, wherein the mounting structure includes a flexible surface configured to bend according to a dimension of the portion of the paint roller frame so as to snap together the mounting structure and the portion of the paint roller frame, and attaching a guide arm to the mounting structure. The guide arm may be configured to rotate in multiple directions relative to a length of the mounting structure. The flexible surface may include at least one of a flexible tab and a clamp. The method may include a two part assembly process.

According to another embodiment, a method of manufacturing a paint roller system includes forming a paint roller including a shank portion and forming a guide arm configured to, move relative to a length of the shank portion. The guide arm and the paint roller are sold as a unit. In one example, the guide arm and the paint roller are manufactured integrally, using a fastener or mold.

These and other advantages and features that characterize embodiments are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments.

### V. BRIEF DESCRIPTION OF THE DRAWINGS

FIG. 1 is a perspective drawing of a right-hand side of a paint roller guide that includes a mounting structure configured to snap or press onto a paint roller frame;

FIG. 2 shows a perspective drawing of a left-hand side of a paint roller guide consistent with an embodiment;

FIG. 3 is a perspective top view of painting system that includes a paint roller guide attached to a portion a paint roller;

FIG. 4 is a perspective bottom, left-hand view of painting system that includes a paint roller guide attached to a paint roller shank;

FIG. 5 is a close-up perspective view of a paint roller system that includes a paint roller guide attached to a paint roller shank; and

FIG. 6 is a perspective view of a paint roller system that includes a paint roller guide with an arm guide mounted on a side of a mounting structure.

### VI. DETAILED DESCRIPTION

An embodiment of a paint roller guide maintains a consistent space between a roller cover carried by a roller frame and a surface adjacent to a wall being painted. The maintained space may apply to adjoining walls, ceilings, and trim molding (e.g., base trim, crown molding, window trim, door trim, and decorative trim). The paint roller guide may include a mounting structure with a snap clip system that secures itself to the paint roller frame. The securing may include a corner section of a first bend extending from a cage or shank section of the roller frame that receives the roller cover and onto a section below the first bend, and before or after a second bend that bends back to meet the handle grip of the roller frame (e.g., but before meeting the handle grip). Positioning the paint roller guide on both the corner/rounded section and a straight section of the paint roller shank may provide anti-rotation and prevent sliding. The paint roller may universally fit of most all paint roller frame diameters in the approximate range of about 4.5 mm to about 9 mm.

The roller guide of an embodiment includes a guide arm, attached to the mounting structure, that extends past the roller cover in a direction that is substantially perpendicular to the longitudinal axis of the roller cover and at, a specific position that is slightly below the vertical center axis of the roller cover in order to catch or bump against adjoining surfaces and trim molding. The guide arm may include a ratcheting and self stopping element that allows the guide arm to be rotated back and away, from a vertical forward position to allow for the roller cover to be dipped into the paint pan or bucket for reloading of paint without getting paint on the protective guide arm.

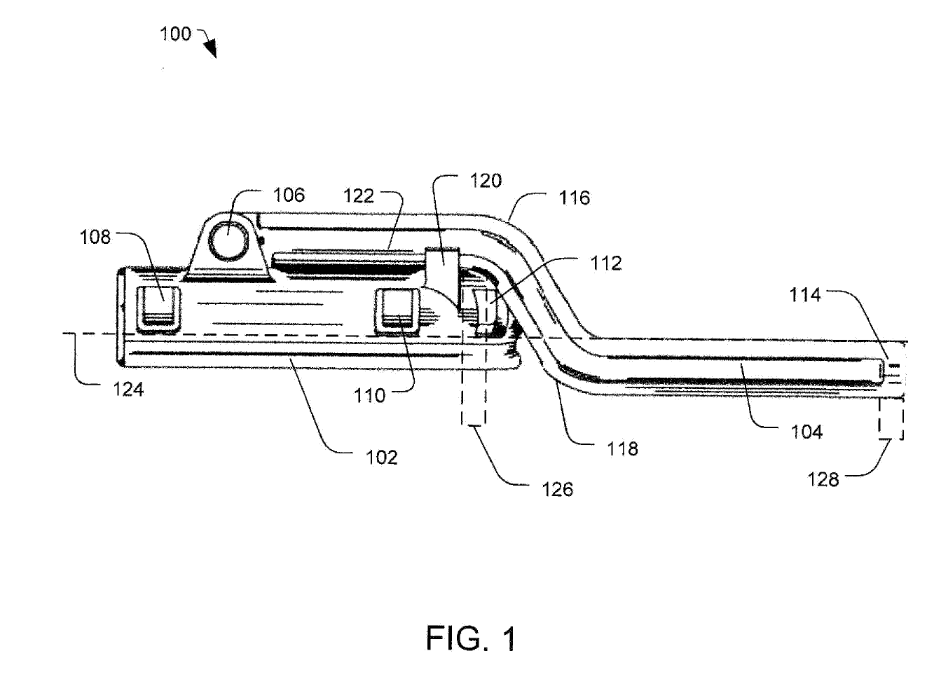

Turning more particularly to the drawings, FIG. 1 is a perspective drawing of a right-hand side of a paint roller guide 100, or apparatus, that includes a mounting structure 102 configured to snap or press onto a paint roller frame. The snap action may attach to a range of different paint roller diameters. For example, the mounting structure 102 may attach to diameters ranging from about 4.5 mm to about 9 mm. To this end, flexible tabs 108, 110, 112 may releasably engage the paint roller shank when mounted.

A guide arm 104 may be attached to the mounting structure 102. The guide arm 104 may function to maintain a desired distance between a wet roller cover and a surface contacting or proximate an end 114 of the guide arm 104. The guide arm 104 may be configured to pivot on a rotating joint 106. The rotating joint 106 may include at least one of a ratchet joint and a ball and socket joint. The guide arm 104 may be configured to rotate in multiple directions relative to a length of the mounting structure 102.

According to an embodiment, the paint roller guide 100 may be assembled using a two part assembly process. For example, the mounting structure 102 may attach to the guide akin 104 using the rotating joint 106.

As shown in FIG. 1, the guide arm 104 may include an offset curvature. For example, curvatures 116, 118 help define portions of an S-curve that may allow the guide arm 104 to sit in line and slightly below a plane of the roller frame shank. This positioning may allow that the guide arm 104 to catch a lip of narrow trim molding (e.g., to protect the ceiling from a wet roller). Another embodiment may feature an L-shaped offset curvature in the guide arm. Similarly, another embodiment may include a guide arm that has, an L-shaped tip/end. The S-curve arm design (or an L-shaped tip or guide arm, as described herein) may be, designed so that a portion of the guide arm 104 (or guide arm tip) is positioned below the perpendicular and center axis plane to the roller cover and below the vertical plane of the roller frame shank to ensure the guide arm catches even low profile trim molding. Dashed line 124 demonstrates how a top edge of the guide arm 104 is positioned below where a roller shank (not shown) is seated within the mounting structure 102. Dashed structure 126 corresponds to an L-shaped dropdown from the guide arm 104 (of another embodiment), and dashed structure 128 shows an L-shaped dropdown from the tip 114 (of another embodiment).

While flexible tabs are shown in FIG. 1, another embodiment may include a mounting structure that has flexible properties sufficient to snap around a paint roller without flexible tabs. Another embodiment may include clamps or other fasteners. For instance, press fit anchors may be positioned to clamp the portion of the paint roller to the mounting structure. Still another embodiment may include hook and loop fasteners, straps or other fasteners configured to securely attach the mounting structure.

The end 114 of the guide arm 104 may be rounded, squared, or formed into an L-shape. The guide arm 104 may (e.g., friction) lock or otherwise be secured into place using a locking mechanism 120. For example, a rib or ridge 122 of the guide arm 104 may snap clip securely into place with a corresponding edge of the locking mechanism 120.

A length of the guide arm may be fixed or adjustable. For instance, the guide arm may have a fixed length that maintains a specific distance between a roller sleeve and the adjacent surface. Where so configured, an embodiment may include a telescoping mechanism along the guide arm. The telescoping guide arm may include multiple sections that allow a telescoping section to slide over and past a portion of another section of the guide arm. The telescoping portion may be locked into place relative to the other portion to achieve a desired length of the guide arm, as well as to prevent buckling or unlocking when in use.

The guide arm may be constructed from a material that will not scuff or mar dry wall or trim. The entirety of the paint roller guide may be constructed using a plastic, metal, wood, ceramic, glass, resin, polymer, or other virtually any other material. A thickness of the paint roller guide may be less than a quarter inch, thus maintaining a relatively slim profile comparable to the covered roller shank. The slim profile may facilitate paint application in relatively narrow paint trays and pans.

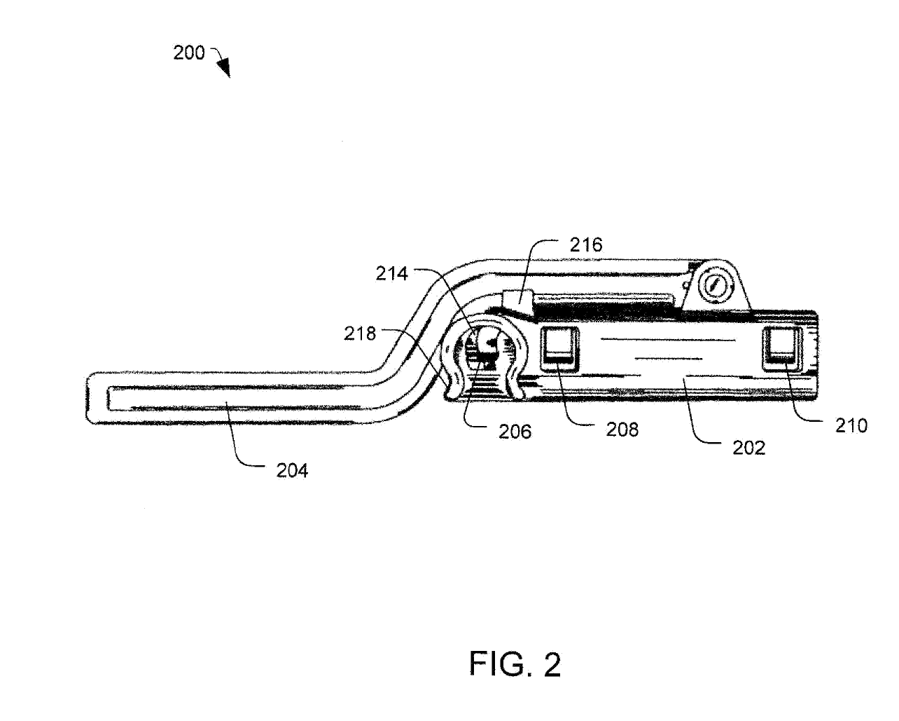

FIG. 2 shows a perspective drawing of a left-hand side of a paint roller guide 200 consistent with an embodiment. The paint roller guide 200 includes mounting structure 202 and a guide arm 204. Flexible tabs 206, 208, 210 are included in the mounting structure 202.

The internal flexible tabs 206, 208, 210 may be molded to grip the smaller diameter range of shanks. For instance, the embodiment of FIG. 2 includes five grip clips/tabs; two on each side of the mounting structure 102 and one in a corner round. Other embodiments may include only one or multiples. When the mounting structure 202 is pressed onto a medium to large diameter shank of a roller, narrower flexible tabs 206, 208, 210 may push outward through the open windows to grip the portion of the paint roller at the same diameter as the rest of the mounting structure 202.

The embodiment of the apparatus 200 includes an open end 214 to accommodate a portion of a paint roller shank leading to where a roller cover is attached. A horseshoe shaped flange 218, along with the pliable nature of the flexible tabs and/or mounting structure material, facilitates the snap (e.g., without mechanical fastener) attachment to the paint roller shank. The guide arm 204 may be secured using a locking mechanism 216.

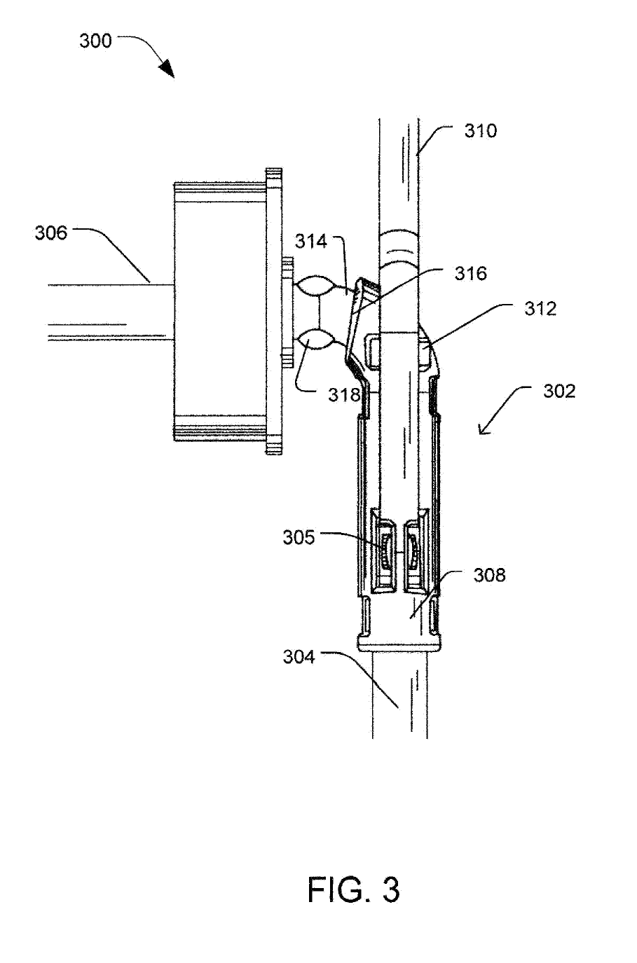

FIG. 3 is a perspective top view of painting system 300 that includes a paint roller guide 302 attached to a portion 304 a paint roller 306. The paint roller guide 302 may be identical or similar to the paint roller guides depicted in FIGS. 1 and 2. A mounting structure 308 may mount onto the paint roller 306 such that a guide UM 310 may maintain a safe distance between a surface and a wet roller.

The paint roller guide 302 includes a rounded shoulder section 312 that attaches to a section 314 of the paint roller 306 having a corresponding curvature. The rounded shoulder section 312 may prevent the paint roller guide 302 from rotating and sliding back when there is pressure on the guide arm 310 (e.g., when contacting a trim, wall, or ceiling surface). As such, the location of the paint roller guide 302 is both on a vertical section of frame, and on the rounded section of the frame shank, where the shank returns into the roller cover. The embodiment may cover variations in a paint roller where the frame is Y-shaped (e.g., angled) and those that are C-shaped, among others, as well.

The rounded shoulder section 312 may include an angled end 316 to accommodate clearance for varying a stop 318 of the paint roller 306. The guide arm 310 may pivot 180 degrees using a pivot joint 305 in order to rotate away from paint in a paint tray when not being used to paint a surface. With a ratcheting mechanism, the guide arm 310 may remain locked in a position of 90-120 degrees pulled back from the forward position.

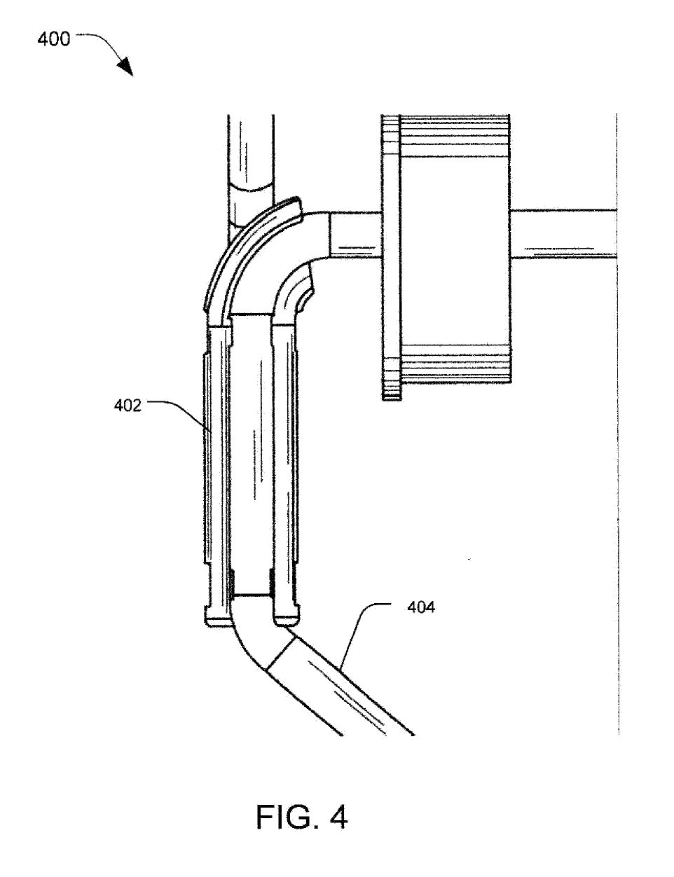

FIG. 4 is a perspective bottom, left-hand view of painting system 400 that includes a paint roller guide 402 attached to a paint roller shank 404.

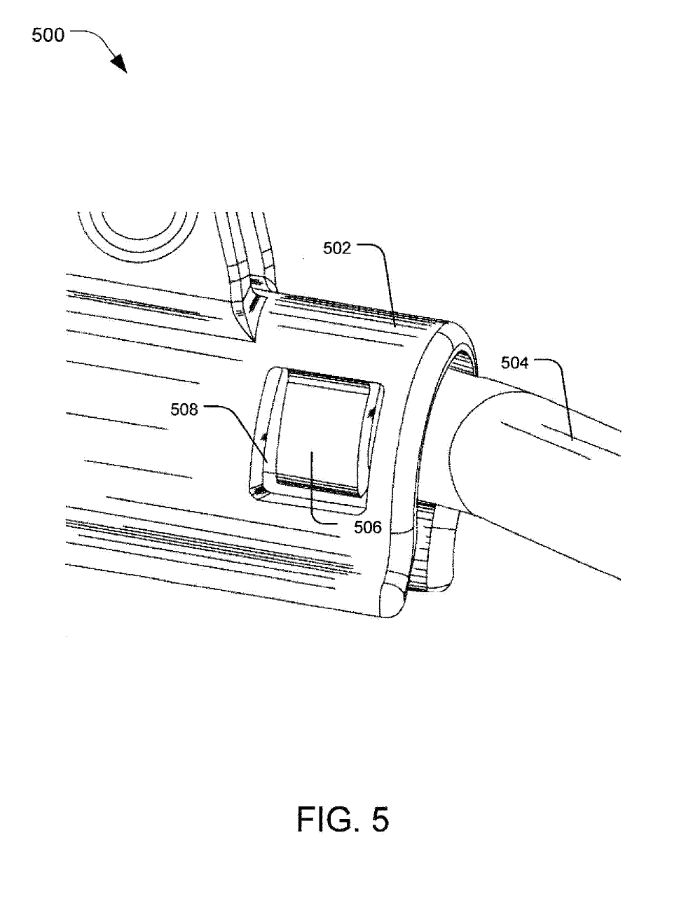

FIG. 5 is a close-up perspective view of a paint roller system 500 that includes a paint roller guide 502 attached to a paint roller shank 504, A flexible tab 506 may be mounted on the interior of the paint roller guide 502 and may flex within a cutout window 508. The flexible tab 506 may, absorb stress and protect the mounting structure from stretching and deformation. The flexible tab 506 may grip a smaller diameter shank but may also spring outward to or beyond the sidewall opening/window 508 to allow the mounting structure to fit larger diameter frames.

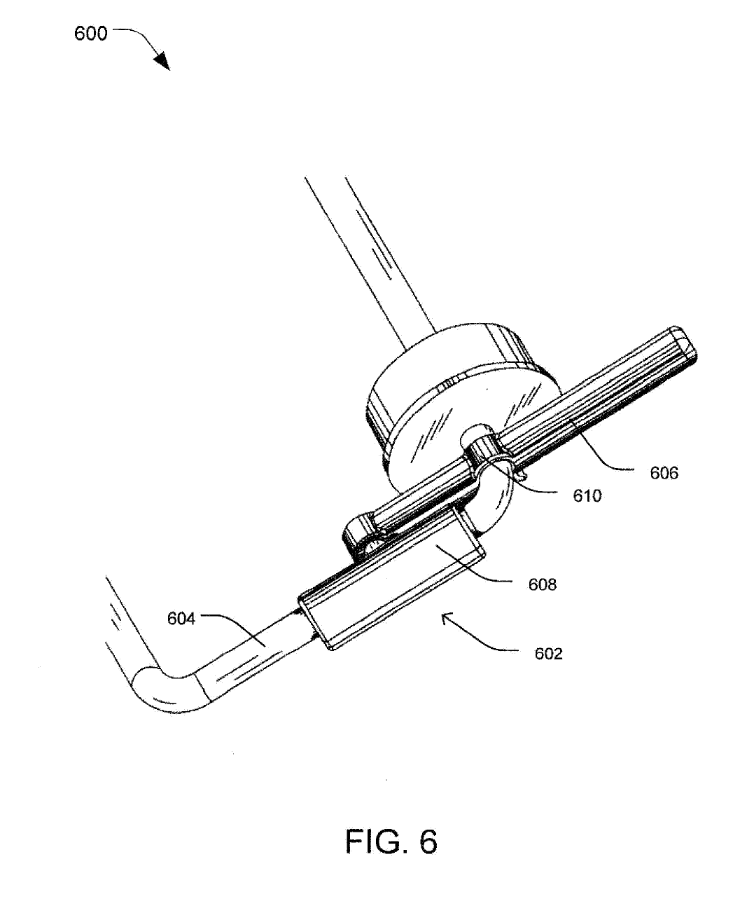

FIG. 6 is a perspective view of a paint roller system 600 that includes a paint roller guide 602 attached to a paint roller shank 604. An arm guide 606 of the paint roller guide 602 is mounted on a side of a mounting structure 608. A portion 610 of the arm guide 606 snaps onto the paint roller shank 604. In another embodiment, the arm guide may be mounted on the opposite side of the mounting structure, or underneath the mounting structure.

While some embodiments described herein may be assembled using two or more parts, other embodiments may be formed integrally. For example, a paint roller guide may be molded integrally as part of a paint roller system.

Those skilled in the art may make numerous uses and modifications of and departures from the specific apparatus and techniques disclosed herein without departing from the inventive concepts. Consequently, the disclosed embodiments should be construed as embracing each and every novel feature and novel combination of features present in or possessed by the apparatus and techniques disclosed herein and limited only by the scope of the appended claims, and equivalents thereof.

1. An apparatus, comprising:
a mounting structure configured to be positioned proximate a portion of a paint roller frame;
a flexible surface configured to bend according to a dimension of the portion of the paint roller frame so as to snap together the mounting structure and the portion of the paint roller frame; and
a guide arm configured to move relative to a length of the mounting structure.

2. The apparatus of claim 1, wherein the flexible surface comprises at least a portion of the mounting structure.

3. The apparatus of claim 1, wherein the flexible surface includes a flexible tab.

4. The apparatus of claim 1, wherein the flexible surface includes a spring clamp.

5. The apparatus of claim 1, wherein the apparatus is assembled using a two part assembly process.

6. The apparatus of claim 1, wherein a length of the guide arm is at least one of adjustable and fixed.

7. The apparatus of claim 1, wherein the portion of the paint roller frame has a diameter ranging from about 4.70 mm to about 9 mm.

8. The apparatus of claim 1, wherein the mounting structure is proximate a bend, or corner section, of the paint roller frame.

9. The apparatus of claim 1, wherein the guide arm includes at least one of a squared tip, pointed tip, rounded tip, and an L-shaped tip.

10. The apparatus of claim 1, further comprising a rotating joint used to attach the guide arm to the mounting structure.

11. The apparatus of claim 10, wherein the rotating joint includes at least one of a ratchet joint and a ball and socket joint.

12. The apparatus of claim 1, wherein the guide arm includes an offset curvature.

13. The apparatus of claim 1, further comprising a locking mechanism to selectively secure a position of the guide arm relative to the mounting structure.

14. An apparatus, comprising:
a mounting structure configured to be attached to a paint roller frame, wherein a first section of the mounting structure extends in a first direction corresponding to a first direction of the paint roller frame, and wherein a second section extends in a second direction that corresponds to a bend in the paint roller frame; and
a guide arm configured to move relative to a length of the mounting structure.

15. The apparatus of claim 14, wherein the apparatus is assembled using a two part assembly process.

16. The apparatus of claim 14, wherein a length of the guide arm is adjustable.

17. The apparatus of claim 14, wherein the portion of the paint roller frame has a diameter ranging from about 4.70 mm to about 9 mm.

18. A method of manufacturing a paint roller system, the method comprising:
forming a paint roller including a shank portion; and
forming a guide arm configured to move relative to a length of the shank portion, wherein the guide arm and the paint roller are manufactured integrally as a unit.

19. The method of claim 18, wherein the guide arm and the paint roller are formed integrally using a mold.

20. The method of claim 18, guide arm and the paint roller are attached using a mechanical fastener.
